(19) United States
(12) Patent Application Publication
(10) Pub. No.: US 2006/0263569 A1
(43) Pub. Date: Nov. 23, 2006

(54) Optical recording medium

(75) Inventors: Kuo-Hsin Teng, Taipei Hsien (TW); Bryan Huang, Taipei Hsien (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/390,267

(22) Filed: Mar. 28, 2006

(30) Foreign Application Priority Data
May 20, 2005 (TW) 094116468

(51) Int. Cl. B32B 3/02

(52) U.S. Cl. 428/64.4

(57) ABSTRACT

An optical recording medium includes a first substrate, a second substrate and a reflective layer. In this case, the second substrate includes a photochromic dye. The reflective layer is disposed between the first substrate and the second substrate.

### BACKGROUND OF THE INVENTION

1. Field of Invention

The invention relates to an optical recording medium and, in particular, to an optical recording medium with a photochromic dye.

2. Related Art

Due to the progress of multimedia, the demands of storage medium in 3C products, i.e. computer, communication and consumer, regarding to storage density and capacity are increasing. Conventional storage medium could be divided into magnetic information storage medium and optical information storage medium. Optical information storage medium is greatly applied to electronic products, it includes the read-only CD (CD-ROM), write-once CD (CD-R), rewritable CD (CD-RW), read-only DVD (DVD-ROM), write-once DVD (DVD-R), rewritable DVD (DVD-RW, DVD+RW), random-access DVD (DVD-RAM), high definition DVD (HD-DVD), blu-ray disc (BD), etc.

Referring to FIG. 1, a conventional optical recording medium 1, such as a CD-ROM, includes a substrate 11, a reflective layer 12, and a protective layer 13. The substrate 11 having pre-grooves is made of polycarbonate and is formed with an injection molding machine. The reflective layer 12 is disposed over the substrate 11 and is made of metal or alloy such as silver or silver alloy, aluminum or aluminum alloy, or gold or gold alloy. The reflective layer 12 is usually formed by sputtering or evaporation. The optical recording medium 1 can reflect a laser beam with the reflective layer 12, and then the digital data recorded in the optical recording medium 10 can be read.

To protect the reflective layer 12 from oxidation or being scratched, the protective layer 13 is usually disposed on the reflective layer 12. The protective layer 13 is made of acrylic resin monomer. After irradiated with UV light, the acrylic resin monomer can be polymerized and hardened so as to protect the reflective layer 12.

To attract costumers′ attentions, the manufacturers of optical recording media work hard on the development of attractive products, which can increase the market share. Therefore, some manufacturers print the ink of different colors on the protective layer 13, and then use UV light to irradiate the ink to form a printing layer 14. Thus, the appearance of the optical recording medium is more beautiful so as to cause the purchases of customers, and the product competitiveness can be increased.

However, the above-mentioned method only changes the color of the appearance without providing any other additional effect. If the optical recording medium can provide an alerting function by showing different colors, patterns or words at different conditions, the customers can easily determine whether the environmental condition is suitable for storing the optical recording medium or not. For example, if the environmental condition is unsuitable, the warning symbol will appear on the optical recording medium. This novel function is useful and can provide better entertainment and uniqueness so as to cause the purchases of customers.

Therefore, it is an important subject of the invention to provide a novel optical recording medium that can provide a warning function.

### SUMMARY OF THE INVENTION

In view of the foregoing, the invention is to provide an optical recording medium including a photochromic dye.

To achieve the above, an optical recording medium of the invention includes a first substrate, a second substrate and a reflective layer. In the invention, the second substrate includes a photochromic dye, and the reflective layer is disposed between the first and second substrates.

To achieve the above, the invention discloses an optical recording medium, which includes a substrate, a reflective layer and a printing layer. In the invention, the reflective layer is disposed on a surface of the substrate, and the printing layer is disposed on a surface of the reflective layer. The printing layer includes a photochromic dye.

To achieve the above, the invention also discloses an optical recording medium, which includes a cover layer, a substrate, and a reflective layer. In the invention, the substrate includes a photochromic dye and the reflective layer is disposed between the cover layer and the substrate.

As mentioned above, the optical recording medium of the invention utilizes a photochromic dye to detect whether it is located in an unsuitable environment or not. When the environment condition is unsuitable, the warning symbol appears on the optical recording medium for alerting the user. In addition, since the optical recording medium of the invention can show different colors under different environmental light, it can provide better entertainment and uniqueness so as to cause the purchases of customers.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional optical recording medium;

FIG. 2 is a top view of an optical recording medium according to a preferred embodiment of the invention;

FIG. 3 is a sectional diagram of the optical recording medium taken along the doted line a-a′ of FIG. 2;

FIG. 4 is a top view of an optical recording medium according to another preferred embodiment of the invention;

FIG. 5 is a sectional diagram of the optical recording medium taken along the doted line b-b′ of FIG. 4;

FIG. 6 is a top view of an optical recording medium according to yet another preferred embodiment of the invention; and

FIG. 7 is a sectional diagram of the optical recording medium taken along the doted line c-c′ of FIG. 6.

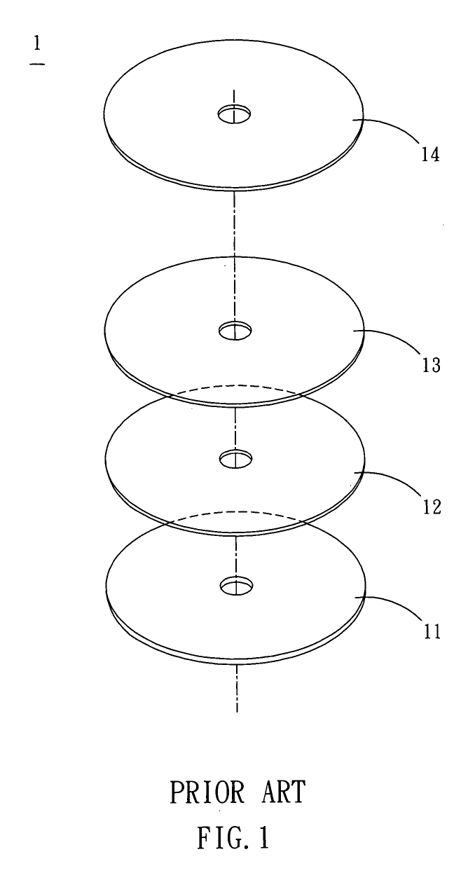

### DETAILED DESCRIPTION OF THE INVENTION

The present invention will be apparent from the following detailed description, which proceeds with reference to the accompanying drawings, wherein the same references relate to the same elements. In the invention, the optical recording medium can be a CD-ROM, a CD-R, a CD-RW, a DVD-ROM, a DVD+/-R, a DVD+/-RW, a DVD-RAM, an HD-DVD, or a Blu-ray disc.

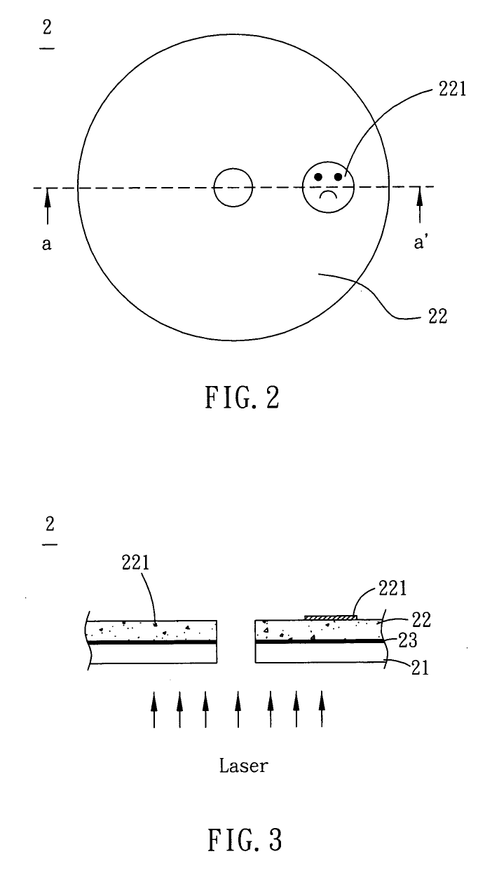

FIG. 2 is a top view of an optical recording medium according to a preferred embodiment of the invention, and FIG. 3 is a sectional diagram of the optical recording medium taken along the doted line a-a′ of FIG. 2. In this embodiment, the optical recording medium is a DVD-ROM. With reference to FIGS. 2 and 3, an optical recording medium 2 includes a first substrate 21, a second substrate 22 and a reflective layer 23.

The first substrate 21 is a transparent substrate with a thickness of approximate 0.6 mm. The first substrate 21 is, for example, made of plastic materials such as acrylic, polycarbonate (PC), or acrylonitrile-butadiene-styrene (ABS). For forming the first substrate 21, the plastic material is applied in an injection molding process with a stamper having data pits and grooves. The optical recording medium 2 records digital data based on the data pits, which can be read with a laser beam.

The second substrate 22 includes a photochromic dye 221, which is doped in the second substrate 22. The thickness of the second substrate 22 is approximate 0.6 mm. In this embodiment, the photochromic dye 221 can show different colors by irradiating the light of different wavelengths. The photochromic dye 221 of the embodiment may be composed of Spyropyran oxazine, Spirooxazine, Azobenzenes, Salicylidene anilines, Fulgides, Spiropyrans, or a photochromic microcapsule dye. The photochromic microcapsule dye appears a color, such as yellow, green, rose-colored, or purple blue, under the sunshine, and becomes colorless indoors. In this embodiment, the photochromic dye 221 is mixed with plastic particles, and then the mixture is processed with an injecting molding machine to fabricate the second substrate 22 with the photochromic dye 221. Herein, the photochromic dye 221 is approximate 0.1 to 0.3% of the second substrate 22.

The reflective layer 23 is disposed between the first substrate 21 and the second substrate 22. In the current embodiment, the reflective layer 23 is made of metal or alloy, such as silver or silver alloy, aluminum or aluminum alloy, gold or gold alloy, semiconductor alloy film, and the likes. The reflective layer 23 is usually formed by sputtering or evaporation.

Alternatively, the photochromic dye 221 may be printed on a surface of the second substrate 22. In detailed, the photochromic dye 221 is mixed with ink, and then the mixture is printed on the surface of the second substrate 22 to form a pattern or word. In this case, the formed pattern is a crying face. Herein, the photochromic dye 221 is approximate 1 to 10% of the ink.

In the present embodiment, the photochromic dye 221 is the material that has an action under the UV light. For example, the photochromic dye 221 may be colorless before irradiated by the UV light, and turns to red after irradiated by the UV light. Accordingly, if the optical recording medium 2 is placed outdoors, it will be irradiated by UV light so that the second substrate 22 will turn to red so as to show the crying face on the optical recording medium 2. The users can thus easily determine that the environment condition is unsuitable for storing the optical recording medium 2 and this environment condition may easily lead to the damage of the optical recording medium 2.

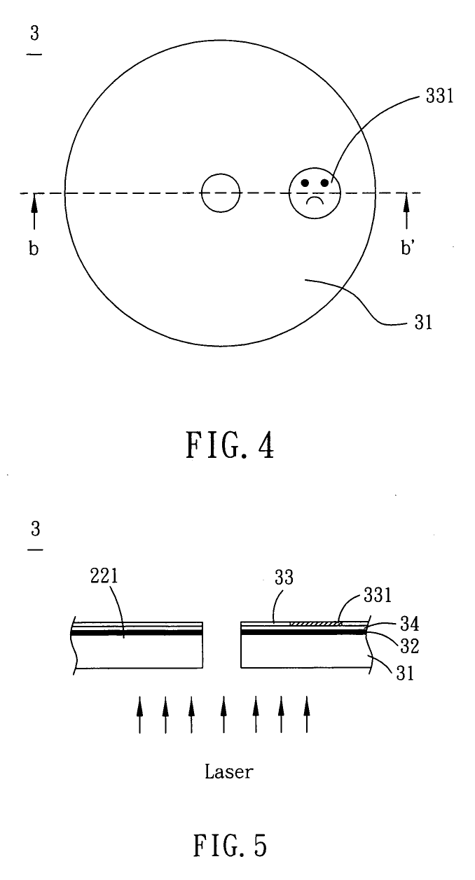

FIG. 4 is a top view of an optical recording medium according to another preferred embodiment of the invention, and FIG. 5 is a sectional diagram of the optical recording medium taken along the doted line b-b′ of FIG. 4. In this embodiment, the optical recording medium is a CD-ROM. With reference to FIGS. 4 and 5, an optical recording medium 3 includes a substrate 31, a reflective layer 32, and a printing layer 33.

The substrate 31 is a transparent substrate with a thickness of approximate 1.2 mm. The substrate 31 is, for example, made of plastic materials such as acrylic, polycarbonate (PC), or acrylonitrile-butadiene-styrene (ABS). For forming the substrate 31, the plastic material is applied in an injection molding process with a stamper having data pits and grooves. The optical recording medium 3 records digital data based on the data pits, which can be read with a laser beam.

The reflective layer 32 is disposed on a surface of the substrate 31. In the current embodiment, the reflective layer 32 is made of metal or alloy, such as silver or silver alloy, aluminum or aluminum alloy, gold or gold alloy, semiconductor alloy film, and the likes. The reflective layer 32 is usually formed by sputtering or evaporation. Furthermore, to protect the reflective layer 32 from oxidation or being scratched, a protective layer 34 is usually disposed between the printing layer 33 and the reflective layer 32.

The printing layer 33 includes a photochromic dye 331. In detailed, the photochromic dye 331 is mixed with ink, and then the mixture is printed on the surface of the reflective layer 32 to form, for example, a crying face.

If the optical recording medium 3 is placed outdoors, it will be irradiated by UV light so that the crying face appears on the optical recording medium 3. The users can thus easily determine that the environment condition is unsuitable for storing the optical recording medium 3 and this environment condition may easily lead to the damage of the optical recording medium 3.

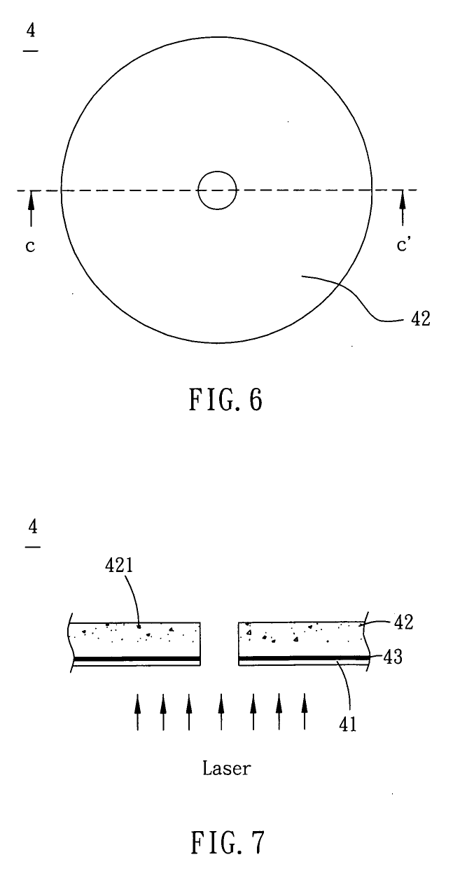

FIG. 6 is a top view of an optical recording medium according to yet another preferred embodiment of the invention, and FIG. 7 is a sectional diagram of the optical recording medium taken along the doted line c-c′ of FIG. 6. In this embodiment, the optical recording medium is a Blu-ray disc (BD). With reference to FIGS. 6 and 7, an optical recording medium 4 includes a cover layer 41, a substrate 42, and a reflective layer 43.

The substrate 42, which is also a protection layer having a thickness of approximate 1.1 mm, is doped with a photochromic dye 421. For forming the substrate 42, the photochromic dye 421 and the plastic material are mixed and then applied in an injection molding process.

The reflective layer 43 is disposed between the cover layer 41 and the substrate 42. In the current embodiment, the reflective layer 43 is made of metal or alloy, such as silver or silver alloy, aluminum or aluminum alloy, gold or gold alloy, semiconductor alloy film, and the likes. The reflective layer 43 is usually formed by sputtering or evaporation. In this case, a laser beam is used to pass through the cover layer 41 for reading data from the optical recording medium 4.

As described hereinabove, the manufacturers may dope the photochromic dye in the substrate or print it on the surface of the optical recording medium for manufacturing the desired products of various specifications. Of course, the manufacturers can both dope the photochromic dye in the substrate and print it on the surface of the optical recording medium depending on the actual needs. Besides, the manufacturers may dope several photochromic dyes in the substrate or print them on the surface of the optical recording medium. Thus, the optical recording medium can present various colors under different lights so as to cause the purchases of customers.

In summary, the optical recording medium of the invention utilizes a photochromic dye to detect whether it is located in an unsuitable environment or not. When the environment condition is unsuitable, the warning symbol appears on the optical recording medium for alerting the user. In addition, since the optical recording medium of the invention can show different colors under different environmental light, it can provide better entertainment and uniqueness so as to cause the purchases of customers.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical recording medium, comprising:
a first substrate;
a second substrate, which includes a photochromic dye; and
a reflective layer, which is disposed between the first substrate and the second substrate.

2. The optical recording medium of claim 1, wherein the photochromic dye is doped in the second substrate.

3. The optical recording medium of claim 2, wherein the photochromic dye is approximate 0.1 to 0.3% of the second substrate.

4. The optical recording medium of claim 1, wherein the photochromic dye forms a meaningful pattern or a word.

5. The optical recording medium of claim 1, wherein the photochromic dye is disposed on a surface of the second substrate.

6. The optical recording medium of claim 5, wherein the photochromic dye is mixed with ink and then printed on the surface of the second substrate.

7. The optical recording medium of claim 6, wherein the photochromic dye is approximate 1 to 10% of the ink.

8. The optical recording medium of claim 1, wherein the photochromic dye comprises Spyropyran oxazine, Spirooxazine, Azobenzenes, Salicylidene anilines, Fulgides, or Spiropyrans.

9. The optical recording medium of claim 1, wherein the optical recording medium is a DVD-ROM, DVD+/-R, a DVD+/-RW, a DVD-RAM, or an HD-DVD.

10. An optical recording medium, comprising:
a substrate;
a reflective layer, which is disposed on a surface of the substrate; and
a printing layer, which is disposed on a surface of the reflective layer and includes a photochromic dye.

11. The optical recording medium of claim 10, wherein the photochromic dye is mixed with ink to form the printing layer, and the photochromic dye is approximate 1 to 10% of the ink.

12. The optical recording medium of claim 10, wherein the photochromic dye comprises Spyropyran oxazine, Spirooxazine, Azobenzenes, Salicylidene anilines, Fulgides, or Spiropyrans.

13. The optical recording medium of claim 10, wherein the optical recording medium is a CD, a CD-R, or a CD-RW.

14. The optical recording medium of claim 10, wherein the photochromic dye forms a meaningful pattern or a word.

15. An optical recording medium, comprising:
a cover layer;
a substrate, which includes a photochromic dye; and
a reflective layer, which is disposed between the cover layer and the substrate.

16. The optical recording medium of claim 15, wherein the photochromic dye is doped in the substrate.

17. The optical recording medium of claim 16, wherein the photochromic dye is approximate 0.1 to 0.3% of the substrate.

18. The optical recording medium of claim 15, wherein the photochromic dye is disposed on a surface of the substrate.

19. The optical recording medium of claim 18, wherein the photochromic dye is mixed with ink and then printed on the surface of the substrate, and the photochromic dye is approximate 1 to 10% of the ink.

20. The optical recording medium of claim 15, wherein the photochromic dye comprises Spyropyran oxazine, Spirooxazine, Azobenzenes, Salicylidene anilines, Fulgides, or Spiropyrans.

21. The optical recording medium of claim 15, wherein a light beam passes through the cover layer for reading data from the optical recording medium, writing data into the optical recording medium, or erasing data of the optical recording medium.

22. The optical recording medium of claim 15, wherein the optical recording medium is a blu-ray disc (BD).

23. The optical recording medium of claim 15, wherein the photochromic dye forms a meaningful pattern or a word.
